(19) United States
(12) Patent Application Publication
(10) Pub. No.: US 2024/0300397 A1
(43) Pub. Date: Sep. 12, 2024

(54) Sliding Truck Bed Platform

(71) Applicants: Cheryl Hoffman, Mooresville, NC (US); Justin Gilbert, Mooresville, NC (US)

(72) Inventors: Cheryl Hoffman, Mooresville, NC (US); Justin Gilbert, Mooresville, NC (US)

(21) Appl. No.: 18/598,089

(22) Filed: Mar. 7, 2024

Related U.S. Application Data
(60) Provisional application No. 63/451,000, filed on Mar. 9, 2023.

(51) Int. Cl. B60P 1/00

(52) U.S. Cl. CPC B60P 1/003

(57) ABSTRACT

A sliding truck bed platform to assist one or more individuals with unloading one or more items from a truck bed of a pick-up truck. The sliding truck bed platform includes a planar base that is bendable and is configured to pull out of the truck bed. The sliding truck bed platform also includes a coating on an underside surface of the planar base, such as to reduce friction when the sliding truck bed platform is pulled out from the truck bed. The sliding truck bed platform additionally includes a plurality of cutout handles disposed on the planar base with which the sliding truck bed platform is controlled.

### CROSS-REFERENCE TO RELATED APPLICATIONS

This U.S. Non-Provisional patent application claims the benefit of U.S. Provisional Patent Application No. 63/451,000 filed on Mar. 9, 2023. The above identified patent application is herein incorporated by reference in its entirety to provide continuity of disclosure.

### BACKGROUND OF THE INVENTION

The present invention relates to a truck bed platform. More particularly, the present invention relates to a sliding truck bed platform.

Due to their convenience and relatively large storage capacity, many people utilize pick-up trucks as their preferred way to transport a multitude of cargo items from one location to another. However, while convenient for transportation, loading, and unloading the cargo items may be difficult as an individual is required to climb into the bed of the pick-up truck in order to reach the cargo items and carry them out. Repeated climbing and lifting may lead to strain on an individual's body and put them at an increased risk of injury. Additionally, continuously having to climb in and out of the pick-up truck increases the amount of time required to load and unload cargo items.

There are currently other truck bed trays and liners available on the market. However, the majority are relatively heavy and permanently affixed to the truck bed which provides some limitations to making loading and unloading cargo items more convenient. Therefore, there is a defined need amongst the known prior art for a sliding truck bed platform that is removable, light in weight and easy to use.

### SUMMARY OF THE INVENTION

In view of the foregoing disadvantages inherent in the known types of sliding truck bed platforms now present in the prior art, the present invention provides a sliding truck bed platform wherein the same may be utilized for providing convenience for the user when using the sliding truck bed platform.

The present system is a sliding truck bed platform that comprises a planar base having a front surface and a back surface and a plurality of handles disposed on the planar base, wherein the sliding truck bed platform is adapted to be placed inside a truck bed of a pick-up truck containing one or more items.

It is an object of the present invention to provide a sliding truck bed platform that has a relatively smooth bottom surface to facilitate sliding the sliding truck bed platform within a truck bed of a pick-up truck.

It is an object of the present invention to provide a sliding truck bed platform that has a relatively rough top surface to facilitate keeping one or more items in place while placed on the sliding truck bed platform.

It is an object of the present invention to provide a sliding truck bed platform that includes a pair of handles disposed on both sides of the sliding truck bed platform for relatively easy maneuvering.

It is an object of the present invention to provide a sliding truck bed platform that eliminates any reaching, climbing, or kneeling in the back of a pick-up truck to obtain one or more items in the truck bed without having to install anything in the bed of the pick-up truck.

It is an object of the present invention to provide a sliding truck bed platform that is removable and relatively cost-effective.

It is an object of the present invention to provide a sliding truck bed platform that is relatively lightweight and is relatively easy to use.

It is an object of the present invention to provide a sliding truck bed platform that is not directly attached to or coupled to the truck bed of a pick-up truck.

It is an object of the present invention to provide a sliding truck bed platform that bends down so that less clearance is required to fully pull it out, but stiff enough to still push back into the truck bed of a pick-up truck with weight or one or more items on it.

It is an object of the present invention to provide a sliding truck bed platform that is made of a bendable plastic that allows a user to bend the end of the sliding truck bed platform while using it.

It is an object of the present invention to provide a sliding truck bed platform that is made of a bendable plastic that bends down so that there is less clearance required to extend it outward while remaining stiff enough to push the sliding truck bed platform back into the truck bed of the pick-up truck.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an embodiment of a side perspective view of a sliding truck bed platform.

FIG. 2 shows an embodiment of an overhead perspective view of the sliding truck bed platform.

FIG. 3 shows an embodiment of an overhead perspective view of a handle disposed on the sliding truck bed platform.

FIG. 4 shows an embodiment of an overhead environmental perspective view of the sliding truck bed platform placed inside a truck bed of a pick-up truck.

FIG. 5 shows an embodiment of a rear environmental perspective view of the sliding truck bed platform pulled outside the truck bed of the pick-up truck.

FIG. 6 shows an embodiment of a side environmental perspective view of the sliding truck bed platform pulled outside the truck bed of the pick-up truck.

### DETAILED DESCRIPTION OF THE INVENTION

Reference is made herein to the attached drawings. Like reference numerals are used throughout the drawings to depict like or similar elements of the sliding truck bed platform. The figures are intended for representative purposes only and should not be considered to be limiting in any respect.

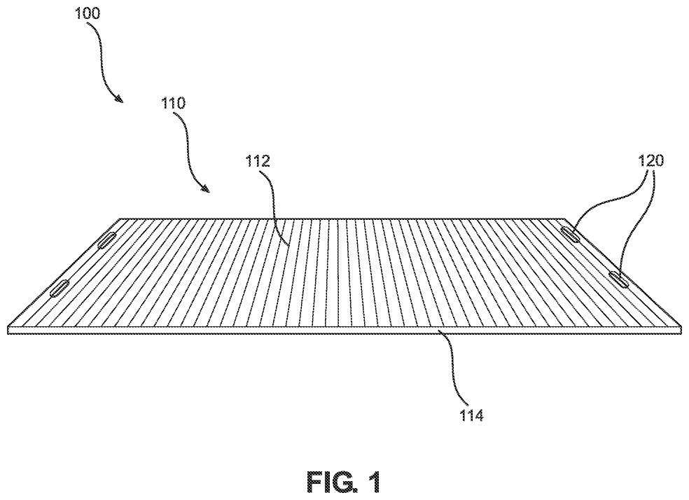

FIG. 1 shows an embodiment of a side perspective view of a sliding truck bed platform 100.

The sliding truck bed platform 100 may include a planar base 110 and a plurality of handles 120.

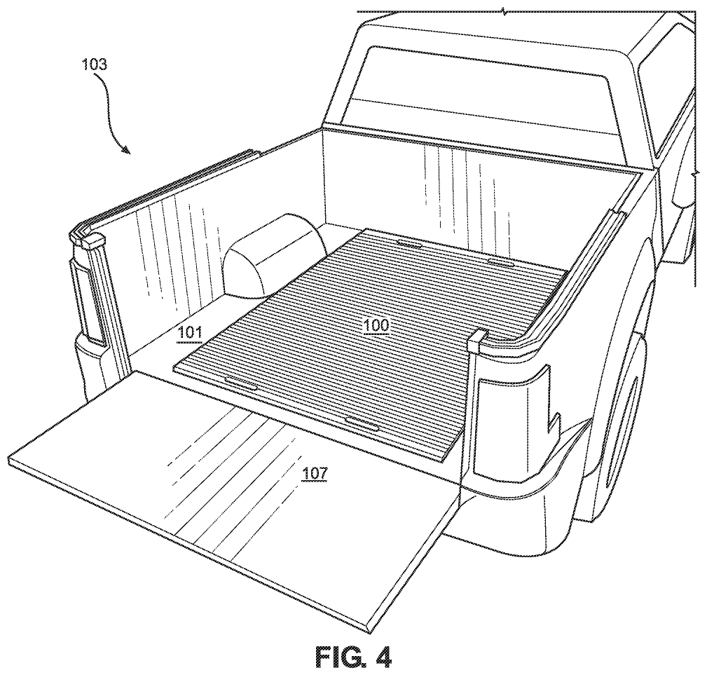

The planar base 110 may have a front surface 112 and a back surface 114. The planar base 110 may have a generally-rectangular shape or the like. The front surface 112 may have a relatively rough texture to prevent one or more items disposed on top of the front surface 112 from moving while the planar base 110 is slid within and outside of the truck bed (FIG. 4, 101). The back surface 114 of the planar base 110 may include a coating to reduce friction when the sliding truck bed platform 100 may be pulled out from the truck bed 101 of the pick-up truck (FIG. 4, 103).

The handles 120 may be disposed on the planar base 110. A first pair of handles 122 may be disposed on a first side of the planar base 110 and a second pair of handles 124 may be disposed on a second side of the planar base 110 for a user to grasp to maneuver the planar base 110.

The sliding truck bed platform 100 may assist one or more users with unloading one or more items 105 from the truck bed 101. The sliding truck bed platform 100 may contain a rough texture on the front surface 112 that helps to prevent the one or more items 105 from sliding around in the truck bed 101 during transport.

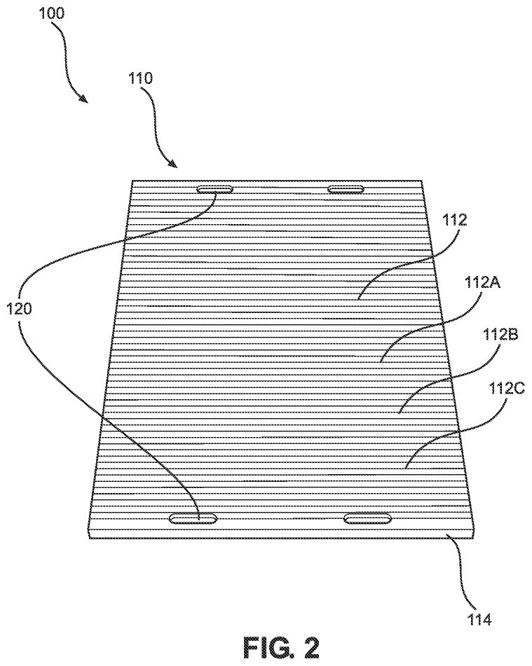

FIG. 2 shows an embodiment of an overhead perspective view of the sliding truck bed platform 100.

The front surface 112 of the planar base 110 may include a surface selected from the group consisting of a corrugated surface 112A, a surface with a plurality of raised protrusions 112B, or a surface with a plurality of grooves 112C, or the like.

The back surface 114 may be relatively smooth and flat and have a Polytetrafluoroethylene (PTFE) or a TEFLON® coating or the like to facilitate sliding the sliding truck bed platform 100 along on the truck bed (FIG. 4, 101).

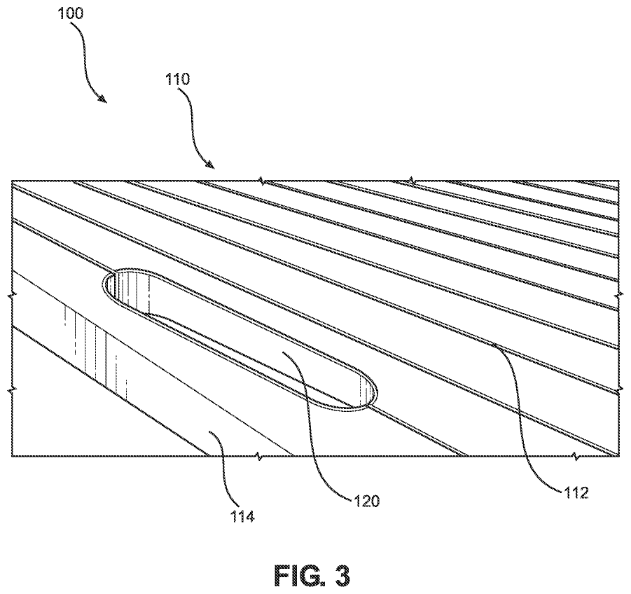

FIG. 3 shows an embodiment of an overhead perspective view of one of the handles 120 disposed on the sliding truck bed platform 100.

The handles 120 may be stamped out of the planar base 110 and are integral to the planar base 110 and have a general-elongated oval shape or the like.

FIG. 4 shows an embodiment of an overhead environmental perspective view of the sliding truck bed platform 100 placed inside a truck bed 101 of a pick-up truck 103.

The sliding truck bed platform 100 may be adapted to be inserted into the truck bed 101 of the pick-up truck 103 or the like. The sliding truck bed platform 100 may be slightly smaller than approximately 8 feet long and 5 feet wide to accommodate a long bed pick-up truck, approximately 6 feet 5 inches long and 5 feet wide to accommodate a standard bed pick-up truck, and approximately 5 feet 8 inches long and 5 feet wide to accommodate a short bed pick-up truck.

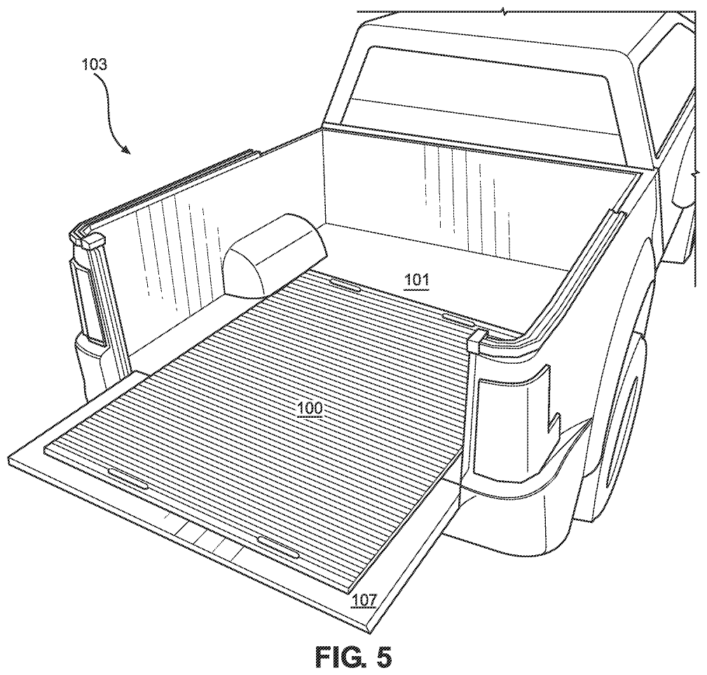

FIG. 5 shows an embodiment of a rear environmental perspective view of the sliding truck bed platform 100 pulled outside the truck bed 101 of the pick-up truck 103.

The sliding truck bed platform 100 may be configured to be removed from the truck bed 101 when the sliding truck bed platform 100 may be pulled out over a tailgate 107 of the pick-up truck 103 by the user.

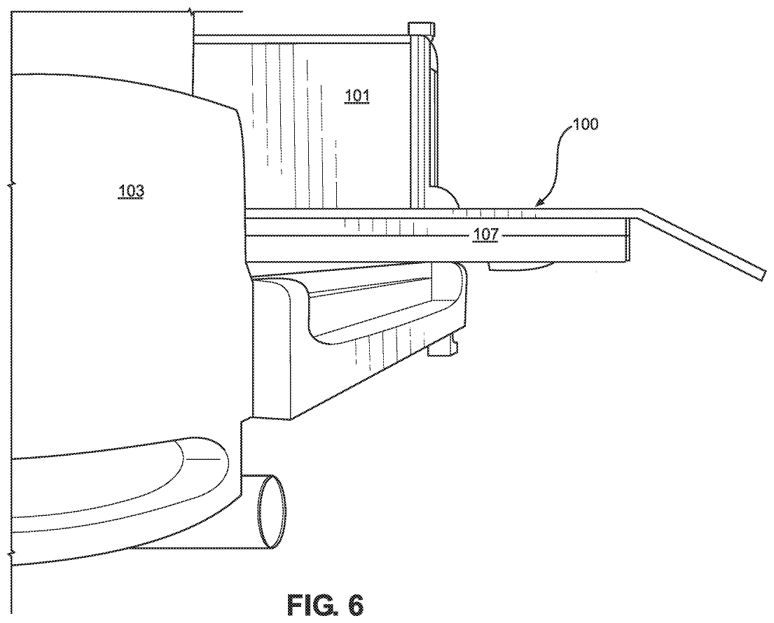

FIG. 6 shows an embodiment of a side environmental perspective view of the sliding truck bed platform 100 pulled outside a truck bed 101 of a pick-up truck 103.

The sliding truck bed platform 100 may be bendable and configured to bend at the tailgate 107 of the pick-up truck 103 by the user.

The sliding truck bed platform 100 may include several different embodiments.

One embodiment of the sliding truck bed platform 100 may include a plurality of clip-on rails (not shown) provided to prevent one or more items (not shown) from sliding at least laterally or sideways.

One embodiment of the sliding truck bed platform 100 may include a secondary frame (not shown) that may be installed to form a table (not shown) which would require a plurality of legs (not shown) that fold inward or attach onto the table that would be available for use.

One embodiment of the sliding truck bed platform 100 may include one or more handles (not shown) provided on each side of the sliding truck bed platform 100.

One embodiment of the sliding truck bed platform 100 may include a tri-fold stand (not shown) having a locking device (not shown).

One embodiment of the sliding truck bed platform 100 may include connection to a plurality of ring anchors (not shown) disposed on the truck bed of the pickup truck (not shown).

One embodiment of the sliding truck bed platform 100 may include a plurality of different sized containers (not shown) that may be attached to the sliding truck bed platform 100.

One embodiment of the sliding truck bed platform 100 may include a plurality of ring anchors (not shown) disposed on the truck bed of the pickup truck (not shown).

One embodiment of the sliding truck bed platform 100 may include a plurality of relatively small openings (not shown) disposed all the way around on the sides of the sliding truck bed platform 100 to accommodate a plurality of different sized cargo nets (not shown) that may be attached so the sliding truck bed platform 100 may be carried out with all of the items on the sliding truck bed platform 100.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A sliding truck bed platform, comprising:
a planar base having a front surface and a back surface; and
a plurality of handles disposed on the planar base;
wherein the sliding truck bed platform is adapted to be placed inside a truck bed of a pick-up truck containing one or more items.

2. The sliding truck bed platform, according to claim 1, wherein the planar base has a generally-rectangular shape.

3. The sliding truck bed platform, according to claim 1, wherein the front surface has a rough texture to prevent the one or more items disposed on top of the front surface from moving while the planar base is slid within and outside of the truck bed.

4. The sliding truck bed platform, according to claim 1, wherein the front surface of the planar base includes a surface selected from the group consisting of a corrugated surface, a surface with a plurality of raised protrusions, or a surface with a plurality of grooves.

5. The sliding truck bed platform, according to claim 1, wherein the back surface of the planar base includes a coating to reduce friction when the sliding truck bed platform is pulled out from the truck bed of the pick-up truck.

6. The sliding truck bed platform, according to claim 5, wherein the coating is a Polytetrafluoroethylene coating to facilitate sliding the sliding truck bed platform along on the truck bed.

7. The sliding truck bed platform, according to claim 1, wherein the back surface is smooth and flat.

8. The sliding truck bed platform, according to claim 1, wherein the handles include a first pair of handles disposed on a first side of the planar base.

9. The sliding truck bed platform, according to claim 1, wherein the handles include a second pair of handles disposed on a second side of the planar base.

10. The sliding truck bed platform, according to claim 1, wherein the handles are stamped out of the planar base.

11. The sliding truck bed platform, according to claim 1, wherein the handles are each integral to the planar base.

12. The sliding truck bed platform, according to claim 1, wherein the handles each have a general-elongated oval shape.

13. The sliding truck bed platform, according to claim 1, wherein the sliding truck bed platform assists one or more users with unloading one or more items from the truck bed.

14. The sliding truck bed platform, according to claim 1, wherein the sliding truck bed platform is slightly smaller than 8 feet long and 5 feet wide to accommodate a long bed pick-up truck.

15. The sliding truck bed platform, according to claim 1, wherein the sliding truck bed platform is slightly smaller than 6 feet 5 inches long and 5 feet wide to accommodate a standard bed pick-up truck.

16. The sliding truck bed platform, according to claim 1, wherein the sliding truck bed platform is slightly smaller than 5 feet 8 inches long and 5 feet wide to accommodate a short bed pick-up truck.

17. The sliding truck bed platform, according to claim 1, wherein the sliding truck bed platform is bendable.

18. The sliding truck bed platform, according to claim 1, wherein the sliding truck bed platform is configured to be removed from the truck bed when the sliding truck bed platform is pulled out over a tailgate of the pick-up truck.

19. The sliding truck bed platform, according to claim 18, wherein the sliding truck bed platform is wrapped around the tailgate of the pick-up truck.
